(19) United States
(12) Patent Application Publication
(10) Pub. No.: US 2006/0044787 A1
(43) Pub. Date: Mar. 2, 2006

(54) Combination flashlight and baton

(76) Inventor: Tae Woo Nam, Yangpyoeng-Gun (KR)

Correspondence Address: ROTH & GOLDMAN, P.A., 523 W. 6TH STREET, SUITE 707, LOS ANGELES, CA, 90014, US

(21) Appl. No.: 11/008,450

(22) Filed: Dec. 9, 2004

(30) Foreign Application Priority Data
Sep. 1, 2004 (KR) 20-2004-0025053

(51) Int. Cl. A45B 3/02; F21L 4/00

(52) U.S. Cl. 362/102; 362/208

(57) ABSTRACT

Disclosed herein is a combination flashlight and baton. The combination flashlight and baton includes a flashlight part and a main baton part. The flashlight part includes a flashlight head equipped with a light bulb, a flashlight barrel, and an electric contact cover. The flashlight barrel is coupled at a first end thereof to the flashlight head, and houses a battery therein to supply electric power to the light bulb. The electric contact cover is coupled to a second end of the flashlight barrel to push and support the battery, thus electrically connecting the battery to the light bulb and preventing the battery from being removed from the flashlight barrel. Further, the main baton part is coupled to the second end of the flashlight barrel in place of the electric contact cover. The main baton part is solid and has a predetermined length to allow a user to easily use it. The main baton part includes a battery support unit provided at a first end of the main baton part to push and support an end of the battery housed in the flashlight barrel, thus electrically connecting the battery to the light bulb, and a cover insert hole provided at a second end of the main baton part to receive the electric contact cover.

### BACKGROUND OF THE INVENTION

1. Field of the Invention

The present invention relates generally to a combination flashlight and baton and, more particularly, to a combination flashlight and baton, which is constructed so that a baton is incorporated into the end of a conventional flashlight, thus being used to prevent crime in an emergency.

2. Description of the Related Art

Generally, a flashlight is constructed so that a light bulb is turned on by a battery to light up a dark place. The flashlight is used mainly in an emergency at night.

A baton has the shape of a club of a predetermined length. The baton is carried by law enforcement and security persons to prevent crime, and is used to quickly disarm or subdue an assailant when necessary.

The conventional flashlight and baton are disadvantageous in that they are independently used, so that it is impossible to execute two functions simultaneously. Thus, when a policeman or patrolman goes around a certain region at night, the person must carry both the flashlight and the baton, so that the person cannot use both hands freely and thereby cannot catch a criminal quickly.

Recently, a combination flashlight and baton has been proposed, which is capable of simultaneously executing the functions of the flashlight and the baton.

The conventional combination flashlight and baton is constructed so that a flashlight is integrally provided at an end of a baton.

However, the conventional combination flashlight and baton has a problem in that the flashlight is integrated with the baton into a single structure, so that a user must carry both the flashlight and the baton when only the function of the flashlight is needed, thus causing inconvenience to the user. Further, the conventional combination flashlight and baton has another problem in that the baton is integrated with the flashlight, so that the combination having the baton may give a bad impression to people at a place where only the flashlight is needed. Thus, there is demand for a novel combination flashlight and baton that is easily assembled or disassembled, thus allowing a user to selectively use a baton or a flashlight.

### SUMMARY OF THE INVENTION

Accordingly, the present invention has been made keeping in mind the above problems occurring in the prior art, and an object of the present invention is to provide a combination flashlight and baton which is easily assembled or disassembled, thus serving as a flashlight while a flashlight part is separated from a baton part, and serving as a baton while the baton part is coupled to the flashlight part.

In order to accomplish the above object, the present invention provides a combination flashlight and baton, including a flashlight part, having a flashlight head equipped with a light bulb, a flashlight barrel coupled at a first end thereof to the flashlight head and housing a battery in a battery chamber thereof to supply electric power to the light bulb, and an electric contact cover coupled to a second end of the flashlight barrel to push and support the battery, thus electrically connecting the battery to the light bulb and preventing the battery from being removed from the flashlight barrel, the combination flashlight and baton further including a main baton part coupled to the second end of the flashlight barrel in place of the electric contact cover, the main baton part being solid and having a predetermined length to allow a user to easily use the main baton part, the main baton part including a battery support unit provided at a first end of the main baton part to push and support an end of the battery housed in the battery chamber of the flashlight barrel, thus electrically connecting the battery to the light bulb, and a cover insert hole provided at a second end of the main baton part to receive the electric contact cover.

According to an aspect of this invention, the combination flashlight and baton further includes at least one auxiliary baton part positioned between the electric contact cover and the main baton part, and inserted into the cover insert hole to ensure a sufficient baton length.

Further, the battery support unit includes a spring to bias the end of the battery, a protrusion to support the spring, and a threaded part engaging with the battery chamber.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view to show a combination flashlight and baton, according to the present invention, when a flashlight part is attached to a baton part;

FIG. 2 is a vertical sectional view to show an interior of the combination flashlight and baton, according to the present invention, when the flashlight part is separated from the baton part; and

FIG. 3 is a perspective view to show the baton part, according to the present invention.

### DESCRIPTION OF THE PREFERRED EMBODIMENTS

Reference now should be made to the drawings, in which the same reference numerals are used throughout the different drawings to designate the same or similar components.

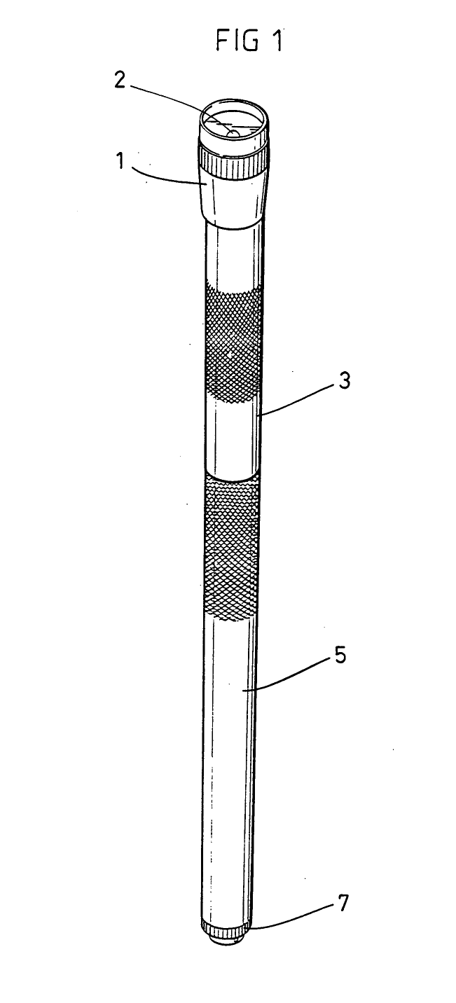

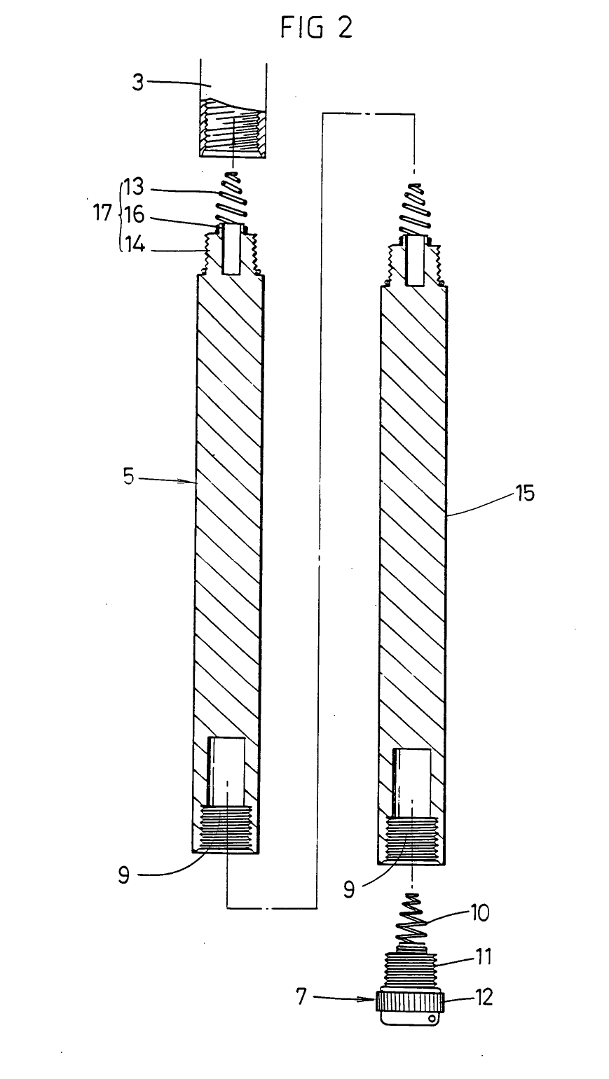

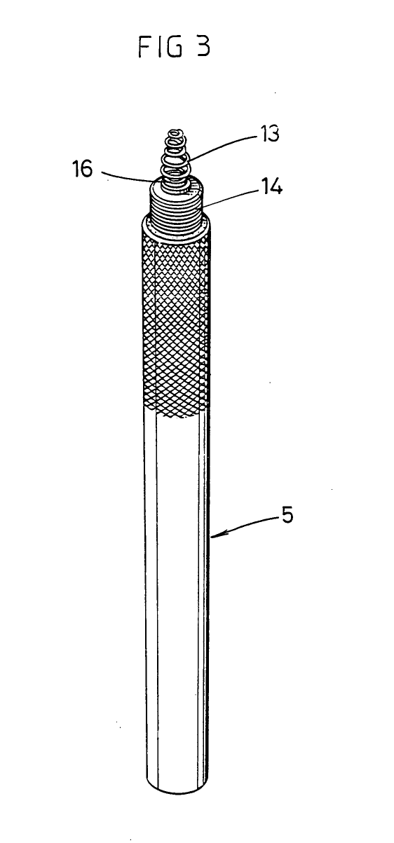

FIG. 1 is a perspective view to show a combination flashlight and baton, according to the present invention, when a flashlight part is attached to a baton part, FIG. 2 is a vertical sectional view to show an interior of the combination flashlight and baton, according to the present invention, when the flashlight part is separated from the baton part, and FIG. 3 is a perspective view to show the baton part, according to the present invention.

As shown in the drawings, the combination flashlight and baton includes a flashlight part and a baton part. The flashlight part includes a flashlight head 1, a flashlight barrel 3, and an electric contact cover 7. A light bulb 2 is installed in the flashlight head 1. The flashlight barrel 3 is coupled at a first end thereof to the flashlight head 1, and houses a battery (not shown) to supply electric power to the light bulb 2. The electric contact cover 7, having a spring 10, a threaded part 11, and a knurled part 12, is fastened to a second end of the flashlight barrel 3 through a screw-type fastening method. The electric contact cover 7 prevents the battery from being removed from the flashlight barrel 3, and pushes the battery to electrically connect the battery to the light bulb 2. When a main baton part 5 that will be described later is attached to the flashlight, the electric contact cover 7 is removed from the flashlight barrel 3 and is then inserted into a first cover insert hole 9 which is provided at a first end of the main baton part 5, so that the electric contact cover 7 is safely stored.

The baton part includes the main baton part 5. When necessary, the main baton part 5 is attached to a second cover insert hole 9 provided at the second end of the flashlight barrel 3 to serve as a nightstick. Further, the main baton part 5 functions to prevent the removal of the battery and push the battery to electrically connect the battery to the light bulb 2, thus turning on the light bulb 2, in place of the electric contact cover 7. Such a main baton part 5 is made of metal and is solid, and has a predetermined length to allow a user to easily use it. Further, a battery support unit 17 is provided at a second end of the main baton part 5 to be coupled to the second end of the flashlight barrel 3. The battery support unit 17 includes a spring 13 to apply pressure to an end of the battery housed in the flashlight barrel 3, thus achieving electric connection of the battery. Such a battery support unit 17 also includes a protrusion 16 to support the spring 13, and a threaded part 14 engaging with the second cover insert hole 9 of the flashlight.

Further, the electric contact cover 7 is removed from the second end of the flashlight barrel 3 and is then fastened to the first cover insert hole 9 of the main baton part 5. However, an auxiliary baton part 15 may be inserted into the first cover insert hole 9 of the main baton part 5.

The auxiliary baton part 15 is sufficiently long to disarm or subdue an assailant, and is carried by a user as an auxiliary means. The general construction of the auxiliary baton part 15 is the same as the main baton part 5. When the auxiliary baton part 15 is used, the electric contact cover 7 is fastened to a third cover insert hole 9 provided at an end of the auxiliary baton part 15.

As described above, the combination flashlight and baton according to the present invention is used widely by law enforcement and security persons who ensure public safety and order. When only the function of the flashlight is required, the main baton part 5 and the auxiliary baton part 15 are separated from the flashlight barrel 3, and then the electric contact cover 7 is coupled to the second end of the flashlight barrel 3, so that it is easy to carry and use. Meanwhile, when it is required to disarm or subdue an assailant, the main baton part 5 or both the main baton part 5 and the auxiliary baton part 15 are coupled to the flashlight barrel 3.

As described above, the present invention provides a combination flashlight and baton, which is constructed so that at least one baton part is easily coupled to an end of a conventional flashlight, thus functioning to prevent crime, in addition to serving as the flashlight, therefore maximizing convenience.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A combination flashlight and baton, comprising a flashlight part, including a flashlight head equipped with a light bulb, a flashlight barrel coupled at a first end thereof to the flashlight head and housing a battery in a battery chamber thereof to supply electric power to the light bulb, and an electric contact cover coupled to a second end of the flashlight barrel to push and support the battery, thus electrically connecting the battery to the light bulb and preventing the battery from being removed from the flashlight barrel, the combination flashlight and baton further comprising:
a main baton part coupled to the second end of the flashlight barrel in place of the electric contact cover, the main baton part being solid and having a predetermined length to allow a user to easily use the main baton part, the main baton part comprising:
a battery support unit provided at a first end of the main baton part to push and support an end of the battery housed in the battery chamber of the flashlight barrel, thus electrically connecting the battery to the light bulb; and
a cover insert hole provided at a second end of the main baton part to receive the electric contact cover.

2. The combination flashlight and baton as set forth in claim 1, further comprising:
at least one auxiliary baton part positioned between the electric contact cover and the main baton part, and inserted into the cover insert hole to ensure a sufficient baton length.

3. The combination flashlight and baton as set forth in claim 1, wherein the battery support unit comprises:
a spring to bias the end of the battery;
a protrusion to support the spring; and
a threaded part engaging with the battery chamber.
